(19) United States
(12) Patent Application Publication
(10) Pub. No.: US 2007/0008311 A1
(43) Pub. Date: Jan. 11, 2007

(54) High resolution and rapid three dimensional object generator advanced

(76) Inventors: Kazutora Yoshino, Eden Prairie, MN (US); Emily Jean Yoshino, Platteville, WI (US)

Correspondence Address: Kazutora Yoshino, 550-11 Shimofujisawa, Iruma, 358, JP

(21) Appl. No.: 11/173,520

(22) Filed: Jul. 5, 2005

(51) Int. Cl. G06T 15/00

(52) U.S. Cl. 345/419

(57) ABSTRACT

The device makes 3 dimensional objects. Micro-displays with quick reactant of material enable to produce the 3 dimensional objects very rapidly and with high resolution. Optionally, the 3 dimensional input device is embedded to the system to create the instant duplication of 3 dimensional images/objects. Image can be artificially generated by CAD model. Imaged beams are projected to the materials. The materials react with imaged beams and are hardened, softened or cut according to the desired shape generated by the imaged beam. Image can be projected to the surface of material or inside of the material to generate 3 dimensional object.

The field is to make rapid prototypes of 3 dimensional structures using various materials.

### PRIOR ART

U.S. Pat. No. 6,504,127 “Laser consolidation methodology and apparatus for manufacturing precise structures” by MaGregor, et al. at Jan. 7, 2003 for cutting material to make 3 D structure using laser scanner. But this method is not fast enough for recent applications.

### BACKGROUND OF THE INVENTION

It is important to make 3 dimensional model & object quickly. One of the reasons is that people like engineers can examine what they are designing. Also, one can input 3 dimensional object and duplicate with the same or various sizes, materials, colors. There are some 3 dimensional object making machines but they are still not fast enough and not high resolution enough for certain applications such as instant prototyping.

### SUMMARY

In order to overcome the speed and resolution of conventional 3 dimensional prototyping, we use the fast image projecting system with fast reactant for the beam projection. First, recent development of the micro-displays is one of factors for us to create 3 dimensional object generator with the fast resolution and high resolution. Second, recent development of materials quick reactant to beams such as photons (microwave range, ultraviolet, visual range, infrared, etc.), electron beam, ultrasound beam, etc. are another factor to let us to produce 3 dimensional object generator. The materials can be reacted chemically, hardened, softened or cut by the energy of the beam (like laser beam). Third, the development of the 3 dimensional image/object input device are available, like scanning system SONY, Konica-Minolta have quick and high resolution 3 dimensional input devices. Fourth, of course, the computer speed of recent year has been increasing a lot which enable us to make the system much faster as well. The way how this system works is to project beams with images to material means that react with those beam. By controlling the image and material with fast computers, one can make 3 dimensional object quickly. Optionally, the 3 dimensional input device to get the 3 dimensional image/object data can be added. Optionally, the relative distance between object and projector can be controlled by base height/position controller or by projector height/position controller. For example, add a layer of liquid chemical source and use blue light to harden the chemical, adjust height of surface to proper position, and add a layer to repeat to create 3D object by adding sliced figures of object.

The improvement of invention of this device may handle small peace(s) of purpose-object(s) with high resolution. For the purpose to make clear 3 dimensional images with 3 dimensional display(s), it may need micro/nano-level control. These are available by printing, thermo/ink-jetting, misty printing, painting, filling, milling, structuring frames/patterns, making lenses. Ultra violet/infrared light/microwave/electron beam may be used for constructing patterns/frames. It may make sharper/high contrast images with clear edge(s). It may also quick printing, quick drying, high color/function embedding, mixing/absorbing of (step-) materials to (sum-) materials/frames /matrix/tensors. (step-) material may be additional/subtractive. It may also make functional object/(multi-) dimensional medium device such as circuits, medical matters (medicine/packaging/filling), pattern generators, operator, music player, speaker, mic, circuit, integrated circuit, micro-processing unit, central processing unit, multiple processing unit, hard drive, hard disc, nano structure object, toy, robot, nano-bot, Nanoid, dna, ma, genetic sequence, code, game, electrical products, soft, hard, objective material, clear film, non-clear film, functional film, yoshino time machine may be made using this invention/process.

Robot hand/arm (with sensors) may be used to have right/proper location direction. This is for the more practical constructing of three dimensional (purpose-) objects. Setting proper locations, angles, and/or color pigments for operation may create more complicated objects.

It may make proper lines/frames/integrated-frames/patterns of circuits and fill insulator/non-conductive material/conductive material/semi-conductive material/functional materials such as transistor material, diodes, resistors, capacitor, integrated circuits, tape, laser disc, compact disc, magnetic element, electrical element, magnetic recording device, electrical recording device, optical recording device, hard disc, memory system, memoria system.

### FIGURES

FIG. 1 shows the example diagram of the concept of head of 3 dimensional object generator.

FIG. 2 shows the alternative example diagram of head of the 3 dimensional object generator.

FIG. 3 shows the example method how to develop the layers/matrix/tensor of multi-dimensional object(s).

FIG. 4 shows the example connection to the 3 dimensional image/object input and/or output.

FIG. 5-1 shows the example diagram of matrix light unit that can be used as the 3 dimensional display(s) with micro-lens. Multiple units may be aligned to create practical three dimensional images/sounds.

FIG. 5-2 shows the side view example diagram of (3D) light/sound unit. Location and direction of wave may be assigned.

FIG. 5-3 shows the top view example diagram of (3D) light/sound unit. Location and direction of wave may be assigned.

### DETAILED EXPLANATION OF FIGURES

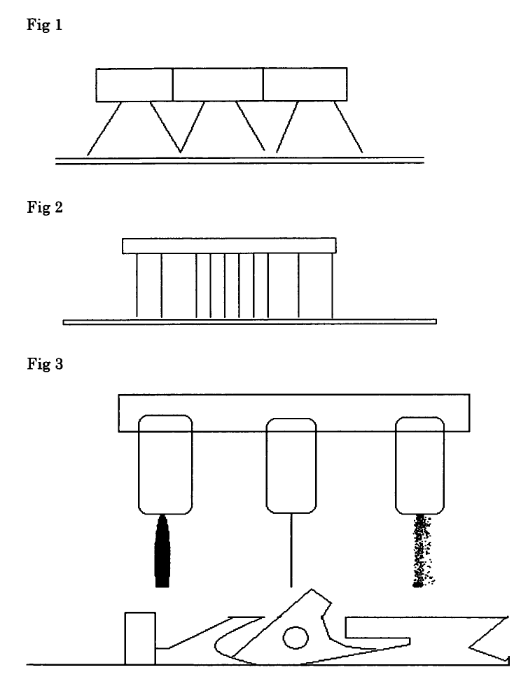

FIG. 1 shows the example diagram of the concept of 3 dimensional object generator. This one shows the solution/functional material 1 emitter system, the beam emitter system, solution/functional material 2 emitter system. solution/functional material 1 and 2 may be the same or different depending on the system/application. Beam emitter system such as arc lamp, laser, electron beam source, microwave, are projected to galvo/DMD/micro-display system and projected to material that react to such beams. The material can be hardened, softened, piled, cut or manipulated depending on the application. Optionally, the location (position and/or direction) of the material may be controlled. Also, optionally, the vari-focal/tele-centric method may be alternatively used to create the sharp images on the surface or inside of the material to create 3 dimensional objects.

FIG. 2 shows the alternative example diagram of the 3 dimensional object generator. Several materials such as solution/functional materials/color pigments/conductors may be put at head of 3 dimensional object generator for faster/convenient operations.

FIG. 3 shows the example method how to develop the layers/sections/entities of 3 dimensional objects. The image/frame/functional structure can be projected to each surface of materials. After the material is framed/functionalized/patterned, harden, soften, added, subtracted, cut, controlled, manipulated or controlled, the system change the level/layer/unit/section to go to next level/layer/unit/section. By repeating this, one can achieve to make 3 dimensional object. It can be done directly inside of material by having focus to right layers as well.

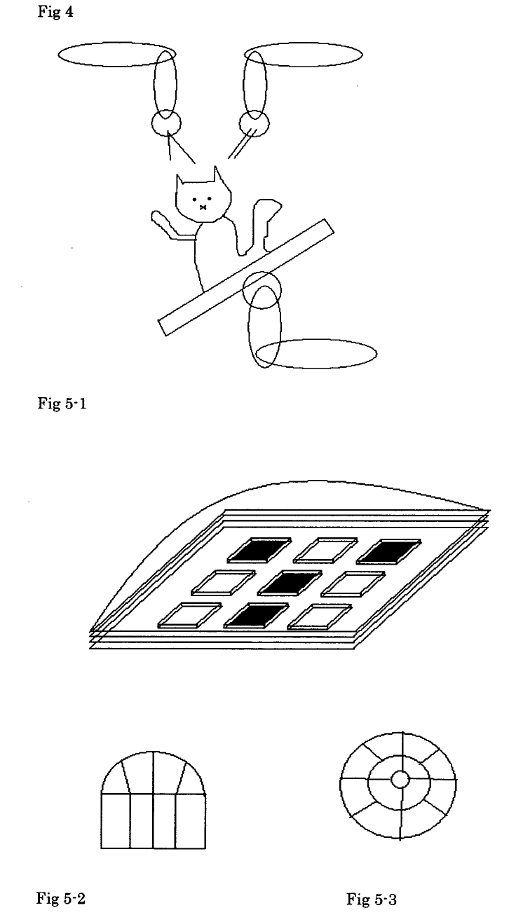

FIG. 4 shows the example connection to the 3 dimensional robot hand/arm device. The implantation of 3 dimensional image/object input device enable to input the 3 dimensional image/object and output (duplicate) the 3 dimensional object in such a short time.

There may be several units used as the unitary bases. Unitary base changes the location such as height and/or angle, to create the proper setting of base in multiple dimensions. It can be made in silicon, metal or organic/inorganic material. But it may be other material/structure to keep/hold/capture/release (at proper timing) material in proper place and directions such as robot hand/arms. The response time is so short that images/patterns/3D patterns can be generated very quickly. This can be used for various applications, purpose-object such as 3 dimensional displays, 3 dimensional object generators, alternatively display with proper light field generator comprising group comprising units, lens, display, slots, patterns, pattern generators, operator, music player, speaker, mic, medicine/medicine package, circuit, integrated circuit, central processing unit, multiple processing unit, hard drive, hard disc, nano structure object, bio-chip, replica, genes, code, toy, game, electrical products, soft, hard, objective material, functional film, yoshino time machine.

Multiple degrees of freedom may be achieved.

FIG. 5-1 shows the example unit of 3 dimensional display/sound system/device. Light/laser/pattern maker is making lens/slots/pattern on pixel/pictorial units/sections. This figure shows the example diagram of matrix light unit that can be used as the 3 dimensional display(s) with micro-lens. Multiple units may be aligned to create practical three dimensional images/sounds.

FIG. 5-2 shows the side view example of diagram of alternative (3D) light/sound unit. Location and direction of wave may be assigned.

FIG. 5-3 shows the top view example diagram of alternative (3D) light/sound unit. Location and direction of wave may be assigned.

I claim

1. The three dimensional object generator composed of the group selected from
1) Beam projector means
2) operator means
3) Image generator means
4) Material supply system means
5) Controller means
6) Optionally, input device means
7) Optionally, vari-focal lens means
8) Optionally, object-projector position controller means

2. the claim of [1], wherein said Beam projector means is composed of the group selected from beam, photon generator, electron generator, particles generator, ion generator, laser, arc lamp, visible light, ultra violet light, infrared light, microwave, ultrasound, ultra violet beam, ultra violet laser, blue ray laser, touching, diode array, pattern generator, laser pattern maker, laser array, diode lasers, diode layers,

3. the claim of [1], wherein said operator means is composed of the group selected from
proper combination of lenses, tele-centric lens system, vari-focal lens system, magnetic lens system, optical lens system, reflector, lens-less beam navigator system, touching, cutters, adder, subtraction maker

4. the claim of [1], wherein said Image generator means is composed of the group selected from
micro-display, photo-display, pattern generator, three dimensional pattern generator, multi-layer patterns generator, digital mirror device, liquid crystal, liquid crystal on silicon, grating light valve, matrix grating light valve, matrix light unit, touching, touching panel

5. the claim of [1], wherein said Material supply system means is composed of the group selected from
liquid plastic, metal, plastic, liquid material, solid material, gas material, photo-sensitive material, electron-sensitive material, materials that react with beams, color pigment, purpose-object, purpose-material, desired material, proper material to act properly, material with right behavior, touching material

6. the claim of [1], wherein said controller means is composed of the group selected from
material supply controller, image controller, height controller, valve controller, input image controller, computer, drivers, position controller, angle/direction controller, color controller, function controller, wave controller, robot hands, robot arms, mechanical pen, physical character modifier/setter, touching control

7. the claim of [1], wherein the said Input device means is composed of the group selected from
sensors, photo sensors, position sensor, On sensor, color sensor, information sensor, actual sensor, photo sensor, sound sensor, temperature sensor, vibration sensor, field sensor, potential sensor, triangular 3 dimensional image input devices, mesh-oriented 3 dimensional image input device, the-slicing type 3 dimensional image input devices, multi-eyes 3 dimensional image input device, single eye vari-location 3 dimensional image input devices, single eye mono-locaion 3 dimensional image input devices, ultrasound 3 dimensional image input devices, general 3 dimensional object input device, touching object device

8. the claim of [1], wherein the said vari-focal lens means is composed of the group selected from
piezo-electric lens, lens with motion generator, mechanical lens, deformable lens, acousto-optic lens, electro-optic lens, lenses that changes the focus with control

9. the claim of [1], wherein the said object-projector position controller means is composed of the group selected from
base right direction/position controller, projector right direction/position controller, tank right direction/position controller, micro-display right direction/position controller.

10. the matrix unit device composed of the group selected from
1) elementary unit means to set locations and directions
2) frame means to have functions be in proper locations and direction
3) Optionally controller means

11. the claim of [10], wherein said elementary unit means is composed of the group selected from
frames, surface material unit designed to change the height, location and/or angle relative to frames,

11. the claim of [10], wherein said elementary unit means is composed of the group selected from
surface material unit designed to change the height, location and/or angle relative to the frame

13. the claim of [10], wherein said frame is composed of the group selected from
frame, made frames, patterns, the base that support the elementary unit, units with stability, immovability, or movability.

14. the claim of [10], wherein said controller means is composed of the group selected from
the controlling system to control each element of said elementary unit means and optionally base frame means

15. the process of making purpose-object with combinational group comprising
1) process to set/adjust entity to be at proper status such as proper image, color, position and direction
2) process to paint entity
3) process to make pattern/frames
4) process to paint/fill pattern/frames/inside of frames/outside of frames
5) process to sense/code/decode action/situation/status/entity
6) process to repeat 1) to 5) proper times to build simple/complicated multi-dimensional structures

16. In the claim of 15, wherein process to paint entity comprising group comprising
emitting, scattering, jetting, adding, subtracting, multiplying, dividing, airing, winding, vaporizing, spraying methods, air brushing, smoothing, touching, milling, assembling, painting/mixing for solution

17. In the claim of 15, wherein process to make pattern/frames comprising group comprising
beam projection, ultra violet laser scattering, patterning, hardening/softening photo-sensitive material, make patterns/frames, assembling, piling, composing, adding, subtracting, multiplying, dividing, con-setting, holing, making position, making direction, making layers, brushing, smoothing, touching, milling, optically constructing, constructing, structuring patterns/frames

18. In the claim of 15, wherein process to paint/fill pattern/frames/inside of frames/outside of frames comprising group comprising
emitting, scattering, jetting, adding, subtracting, multiplying, dividing, airing, winding, vaporizing, spraying methods, air brushing, smoothing, touching, milling, assembling, painting/mixing for solution to pattern/frames/inside of frames/outside of frames

19. In the claim of 15, wherein process to sense/code/decode action/entity/situation/status comprising group comprising, sensing, measuring, checking, comprising group comprising, sensing, measuring, checking,

20. In the claim of 15, wherein purpose-object comprising group comprising display, three dimensional display, alternatively display with proper light field generator comprising group comprising units, lens, display, slots, patterns,
pattern generators, operator,
music player, speaker, mic,
medicine/medicine package,
circuit, integrated circuit, central processing unit, multiple processing unit,
hard drive, hard disc,
nano structure object, diode layers, nano-tubes, field emission matrix, field emission layers,
toy, game, electrical products, soft, hard,
objective material, robot, nano-bot, Nanoid, bio-chip, replica, dna, rna, genetic
sequence, code,
functional film,
yoshino time machine.
